(19) United States
(12) Patent Application Publication
(10) Pub. No.: US 2016/0101853 A1
(43) Pub. Date: Apr. 14, 2016

(54) VERTICAL TAKE OFF AND LANDING AIRCRAFT

(71) Applicant: David Wayne Toppenberg, Ypsilanti, MI (US)

(72) Inventor: David Wayne Toppenberg, Ypsilanti, MI (US)

(21) Appl. No.: 14/511,982

(22) Filed: Oct. 10, 2014

(51) Int. Cl. B64C 29/00

(52) U.S. Cl. CPC B64C 29/0033

(57) ABSTRACT

A vertical takeoff and landing aircraft is provided. The aircraft includes a fuselage having a first end, a second end, and a center of gravity in between the first end and the second end. Wings may extend from the side of the fuselage. The wings may include a canard at the first end, and a wing at the second end. The present invention may further include a pair of engines pivotally attached on either side of the fuselage and substantially aligning with the center of gravity.

### BACKGROUND OF THE INVENTION

The present invention relates to an aircraft and, more particularly, to a vertical takeoff and landing aircraft.

Commuters need fast door to door transportation to get to and from work, particularly in urban areas. Current automobile technology limits commuters to roads which are increasingly congested. Lengthy commute times result which limits the growth of current urban centers. Current conventional takeoff and landing aircraft require runways which prevent them from providing practical door to door transportation.

Helicopters and gyro copters, while enabling vertical takeoff, cannot pivot their propellers for horizontal flight. This limits their cruising speed typically to <200 knots which reduces their utility in shortening commutes in ever enlarging urban areas. Existing straight wing pivoting propeller aircraft designs do not directly scale down to fit into a typical two car garage or enable them to economically carry two to five passengers for a typical commute.

As can be seen, there is a need for an improved aircraft for urban commuting.

### SUMMARY OF THE INVENTION

In a first aspect of the present invention, an aircraft comprises: a fuselage comprising a first end, a second end, and a center of gravity in between the first end and the second end; wings comprising at least a canard wing and a second wing extending from the fuselage; and a pair of engines attached on either side of the fuselage substantially aligning with the center of gravity, wherein the pair of engines are pivotally mounted and comprise a first pivot position in which the pair of engines propel the aircraft in a substantially horizontal direction, and a second pivot position in which the pair of engines propel the aircraft in hover and in a substantially vertical direction.

In another aspect of the present invention, an aircraft comprises: a fuselage comprising a first end, a second end, and a center of gravity in between the first end and the second end; a canard wing at the first end of the fuselage; a second wing at the second end of the fuselage; and a pair of engines attached on either side of the fuselage substantially aligning with the center of gravity, wherein the pair of engines are pivotally mounted and comprise a first pivot position in which the pair of engines propel the aircraft in a substantially horizontal direction, and a second pivot position in which the pair of engines propel the aircraft in a substantially vertical direction.

These and other features, aspects and advantages of the present invention will become better understood with reference to the following drawings, description and claims.

### BRIEF DESCRIPTION OF THE DRAWINGS

FIG. 1 is a perspective view of the present invention;

FIG. 2 is a perspective view of the present invention demonstrated in engine-rotated configuration;

FIG. 3 is a top view of the present invention;

FIG. 4 is a front view of the present invention;

FIG. 5 is a side view of the present invention;

FIG. 6 is a side view of the present invention demonstrating key forces in hover;

FIG. 7 is a side view of the present invention demonstrating key forces in cruise;

FIG. 8 is a perspective view of the rotation of the engine of FIG. 1; and

FIG. 9 is a perspective view of the engine bracket.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Broadly, the present invention includes a vertical takeoff and landing aircraft. The aircraft includes a fuselage having a first end, a second end, and a center of gravity in between the first end and the second end. Wings may extend from the side of the fuselage. The wings may include a canard at the first end, and a forward swept wing at the second end. The present invention may further include a pair of engines pivotally attached on either side of the fuselage and substantially aligning with the center of gravity.

The present invention includes a vertical takeoff and landing aircraft that can be parked in a two car garage. This vertical takeoff and landing aircraft which fits in a two car garage eliminates the need for runways while still providing the high cruising speed to enable commuters to live far from urban centers while still working in them. The present invention may enable commuters to avoid the congestion of surface transportation thereby permitting continued growth of urban centers.

The aircraft configuration of the present invention provides vertical takeoff and landing capability while fitting in a two car garage. The present invention does this by locating the center of thrust in hover and center of lift in cruise close to and above the center of gravity. This unique canard, forward swept wing configuration with the propellers, prop fans or other thrust generating devices located between them enables the aircraft to provide vertical takeoff and high cruise speed as the twin thrust axes can pivot to vertical for takeoff and to horizontal for cruising flight.

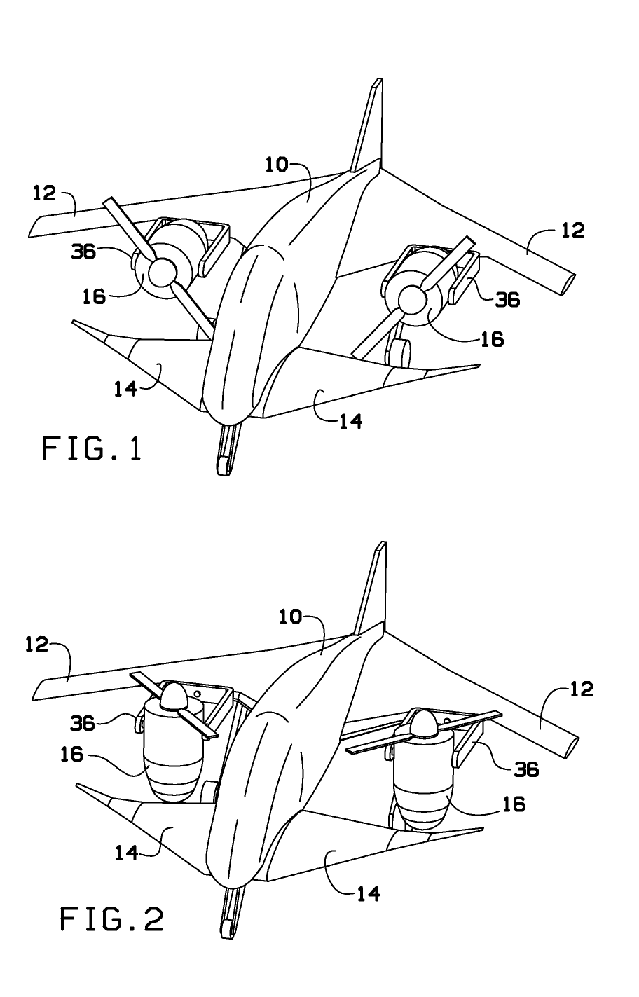

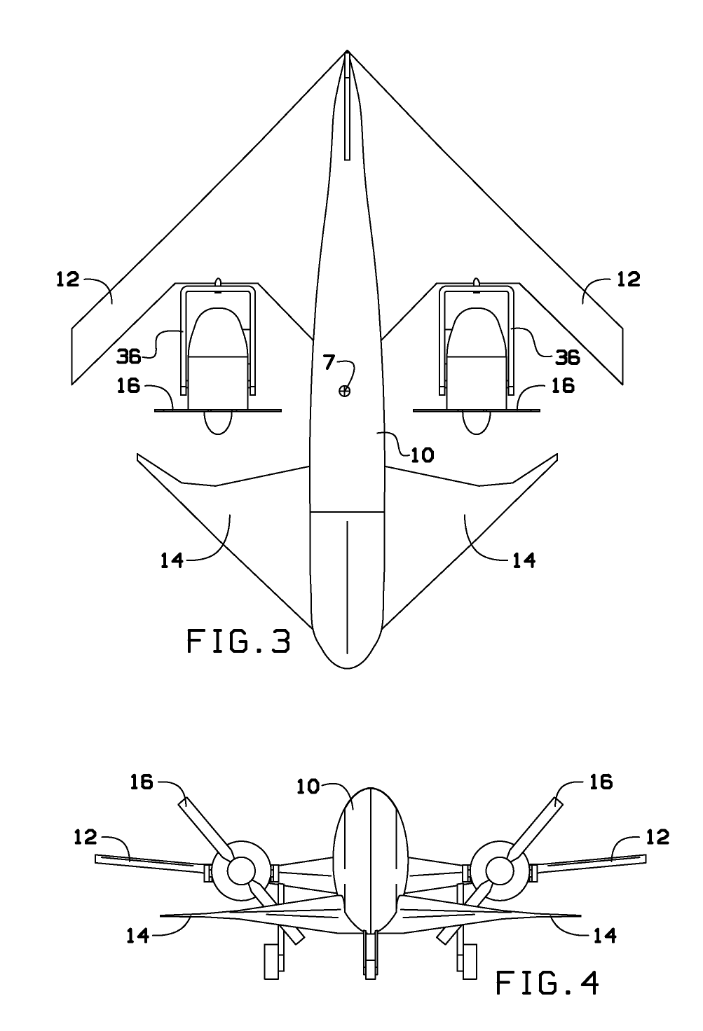

Referring to FIGS. 1 though 9, the present invention includes an aircraft having a fuselage 10. The fuselage 10 has a first end, a second end, and a center of gravity 7 in between the first end and the second end. Wings 12, 14 may extend from the side of the fuselage 10. The wings 12, 14 may include a canard 14 at the first end, and a forward swept wing 12 at the second end. The present invention may further include a pair of engines 16 attached on either side of the fuselage 10 and substantially aligning with the center of gravity 7.

In certain embodiments, the pair of engines 16 are pivotally mounted to the aircraft. In certain embodiments, the pair of engines 16 may be mounted to the forward swept wing 12 by a first engine bracket 36 and a second engine bracket 36, each pivotally securing an engine 16. The engines 16 may be pivoted in a first position and a second position. The first pivot position includes the pair of engines 16 in a position to propel the aircraft in a substantially horizontal direction 18. The second pivot position includes the pair of engines 16 in a position to propel the aircraft in a substantially vertical direction 20.

The engines 16 may include a jet engine, a propeller engine or any appropriate thrust generating device. As illustrated in the Figures, the engine may be a propeller engine 16 including a propeller and an engine cowling. The first pivot (cruising) position may include the engine 16 oriented in a substantially parallel position relative to the aircraft (refer to FIGS. 5 & 7). During horizontal cruising flight, the wing 12 and canard 14 provide a lifting force 22 counteracting the weight force 28, and the engines 16 propel the aircraft in the horizontal direction by providing thrust 18 counteracting the drag force 24. Pitching moments 32 are balanced by the trimming of the canard 14 during cruise in the substantially horizontal direction.

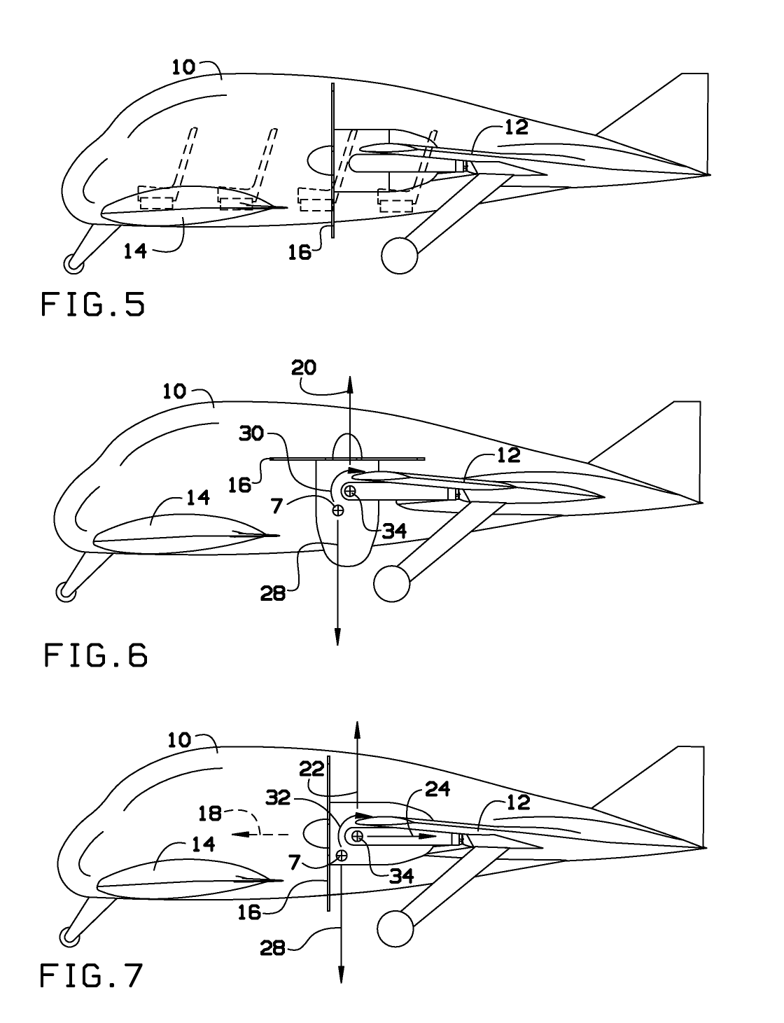

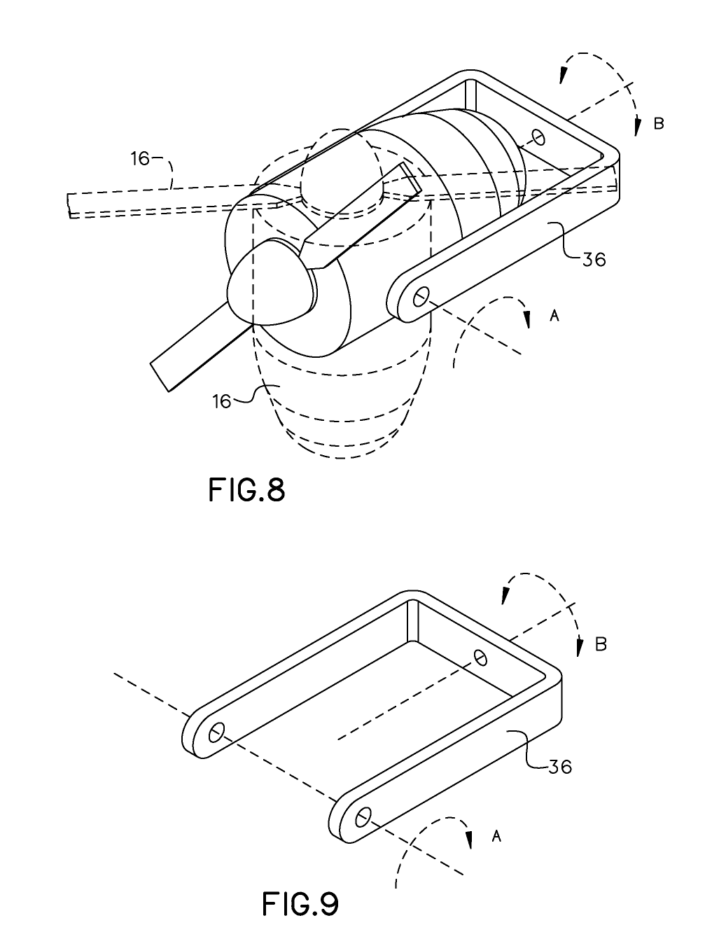

The second pivot (hovering) position may include the engine cowling 16 pivoted downward and the propeller pivoted upward so that the engine 16 is oriented in a substantially perpendicular position relative to the horizontal aircraft fuselage (refer to FIG. 6). In this position, the engine provides thrust 20 in the vertical direction which counter balances the weight force 28. The balancing pitching moment of the present invention is provided by the longitudinal cyclic control of the propeller pitch angles similar to a conventional helicopter (via the swashplate). Roll input can be controlled either by differential throttle or collective between the two engines or lateral cyclic inputs. Further, as illustrated in FIGS. 8 and 9, the engine brackets 36 may be pivotally attached to the wing 12 and may thereby pivot along the longitudinal axis of the plane 10. The engines 16 may pivot along the longitudinal axis of plane 10 to accommodate for wind while the plane 10 is hovering and moving in a vertical position.

The location of the forward swept wing 12 aft of the canard 14, with the propeller/prop fan or other engine/propulsion/thrust generating device 16 enables the location of the center of thrust in hover and line of action of thrust in cruise as well as the center of lift in cruise to be located above and near the center of gravity 7. This configuration enables the aircraft to take off and land vertically, transition to and then cruise horizontally at well over 200 knots while carrying passengers and payload while still being able to be parked in a typical two car garage (16×16×7 ft).

Other configurations of the wing, canard, fuselage, and propulsion devices, including curved canard and wing, straight canard and wing, joined diamond shaped canard and wing, and either tandem or side by side seating could potentially provide similar feasible aircraft configurations where the location of the center of thrust in hover and line of action of thrust as well as the center of lift in cruise would be near and above the center of gravity of aircraft in the fuselage, thereby enabling the aircraft to take off and land vertically, transition to and then cruise horizontally while carrying passengers and cargo, while still being capable of being parked in a typical two car garage (16×16×7 ft).

Construction of the present invention may be similar to that of other existing aircraft. The present invention may be a monocoque construction either with thin aluminum skin riveted to stringers and bulkheads, or made of composite materials laid-up in molds and then joined with structural adhesives. The propulsion components may then be attached and the wiring, flight instruments, and control system modules installed. The interior and exterior trim and cosmetic elements may be added, such as decals, paint themes, etc.

A typical commuter would be able to move this aircraft out of their two car garage, takeoff vertically from their driveway, fly to work or some other destination at a cruising speed of near 300 knots, land vertically and park in a similar two car garage size space (16×16×7 ft) without the need for runways or other airport facilities. This aircraft could also have emergency medical applications as an aerial ambulance, search and rescue, law enforcement, reconnaissance or other military aircraft applications.

It should be understood, of course, that the foregoing relates to exemplary embodiments of the invention and that modifications may be made without departing from the spirit and scope of the invention as set forth in the following claims.

What is claimed is:

1. An aircraft comprising:
a fuselage comprising a first end, a second end, and a center of gravity in between the first end and the second end;
wings comprising at least a canard wing and a second wing extending from the fuselage; and
a pair of engines attached on either side of the fuselage substantially aligning with the center of gravity,
wherein the pair of engines are pivotally mounted and comprise a first pivot position in which the pair of engines propel the aircraft in a substantially horizontal direction, and a second pivot position in which the pair of engines propel the aircraft in hover and in a substantially vertical direction.

2. The aircraft of claim 1, further comprising a first engine bracket and a second engine bracket, each pivotally securing an engine.

3. The aircraft of claim 2, wherein the wings comprise the canard wing at the first end and a second wing at the second end.

4. The aircraft of claim 3, wherein the second wing is a forward swept wing.

5. The aircraft of claim 4, wherein the first engine bracket and the second engine bracket are attached to the forward swept wing on either side of the fuselage.

6. The aircraft of claim 5, wherein the engines are attached to the first engine bracket and the second engine bracket at a pivot point.

7. The aircraft of claim 5, wherein the first engine bracket and the second engine bracket are pivotally connected to the forward swept wing along the longitudinal axis.

8. The aircraft of claim 1, wherein the pair of engines each comprise a propeller end and an engine cowling, wherein the first pivot position comprises the engine oriented in a substantially parallel position relative to the aircraft, and wherein the second pivot position comprises the engine cowling of the engine pivoted downward and the propeller pivoted upward so that the engine is oriented in a substantially perpendicular position relative to the aircraft.

9. An aircraft comprising:
a fuselage comprising a first end, a second end, and a center of gravity in between the first end and the second end;
a canard wing at the first end of the fuselage;
a second wing at the second end of the fuselage; and
a pair of engines attached on either side of the fuselage substantially aligning with the center of gravity,
wherein the pair of engines are pivotally mounted to the second wing and comprise a first pivot position in which the pair of engines propel the aircraft in a substantially horizontal direction, and a second pivot position in which the pair of engines propel the aircraft in a substantially vertical direction.

10. The aircraft of claim 9, wherein the second wing is a forward swept wing.

11. The aircraft of claim 10, further comprising a first engine bracket and a second engine bracket, each pivotally securing an engine.

12. The aircraft of claim 11, wherein the first engine bracket and the second engine bracket are attached to the forward swept wing on either side of the fuselage.

13. The aircraft of claim 12, wherein the engines are attached to the first engine bracket and the second engine bracket at a pivot point.

14. The aircraft of claim 12, wherein the first engine bracket and the second engine bracket are pivotally connected to the forward swept wing along the longitudinal axis.

15. The aircraft of claim 9, wherein the pair of engines each comprise a propeller end and an engine cowling, wherein the first pivot position comprises the engine oriented in a substantially parallel position relative to the aircraft, and wherein the second pivot position comprises the engine cowling of the engine pivoted downward and the propeller pivoted upward so that the engine is oriented in a substantially perpendicular position relative to the aircraft.
